(19) United States
(12) Patent Application Publication
(10) Pub. No.: US 2008/0227432 A1
(43) Pub. Date: Sep. 18, 2008

(54) Activating the Unlocking of a Mobile Terminal

(75) Inventors: Nicolas Lavabre, Marseille (FR); Remy Cricco, Marseille (FR)

Correspondence Address: BUCHANAN, INGERSOLL & ROONEY PC, POST OFFICE BOX 1404, ALEXANDRIA, VA, 22313-1404, US

(73) Assignee: GEMPLUS, Gemenos (FR)

(21) Appl. No.: 11/909,046

(22) PCT Filed: Jan. 19, 2006
(86) PCT No.: PCT/EP06/50313

§ 371 Date: Feb. 29, 2008

(30) Foreign Application Priority Data
Mar. 18, 2005 (FR) 0550706

(51) Int. Cl. H04M 1/66

(52) U.S. Cl. 455/410

(57) ABSTRACT

The invention concerns a method for activating unlocking of a mobile terminal (TM) to be connected to a radio communication network (RR) and co-operating with a smart card (CP), wherein an unlocking activating indicator stored in a first state in the card is periodically read by an application of the terminal to maintain the terminal locked if the indicator is in the first state. A server (SO) transmits an updating message including a state-changing command to the card via the terminal after a predetermined usage time interval so that an application in the card shifts the unlocking activating indicator into a second state. If the unlocking activating indicator is read in the second state by the terminal application, the latter commands the unlocking of the mobile terminal. The interaction between the terminal as well as providing sufficient revenue to the operator who has sold the terminal

The present invention relates to activating the unlocking of a mobile terminal within a cellular radio-communication network.

Currently, an operator sells a user a low-price mobile terminal which is locked by the operator to its own radio-communication network. For a predetermined period of time, the terminal cannot communicate on any network other than that of the operator in order to provide enough income for the operator to which the user has subscribed.

Each mobile terminal is locked by the terminal manufacturer by implementing a secret unlocking algorithm, to which a terminal serial number and an operator code are applied so as to produce an unlocking code which is stored and associated with a lock limiting communication to the operator network only. At the end of the predetermined period of time, at the request of the mobile terminal user, the unlocking code is transmitted to the user, who then inputs it in order to unlock the mobile terminal.

Despite improvements in security in the unlocking process, the unlocking code can easily be obtained by malicious users, who can then subscribe to another operator and use the mobile terminal almost free of charge before the end of the predetermined period of time. The unlocking of the mobile terminal is essentially performed from the mobile terminal and uncontrolled unlocking therefore constitutes a financial loss for operators who are victims of this lack of security.

The aim of the invention is to unlock a mobile terminal after successfully verifying the parameters of a chip card installed in the mobile terminal, after a predetermined period of use of the mobile terminal so as to provide enough income for the operator subsidising the terminal, in particular by the use of its network imposed on the mobile terminal.

In order to achieve this aim, a method of activating the unlocking of a mobile terminal which, before use, is intended to be associated with a radio-communication network and which cooperates with a chip card storing an unlocking activation indicator in a first state, is characterised in that it comprises:

a periodic step of the mobile terminal reading the unlocking activation indicator in the chip card so as to keep the mobile terminal locked if the read unlocking activation indicator is in the first state, and

the following steps of:

transmitting an update message, comprising a state-change command, from server means connected to the network to the chip card via the mobile terminal,

placing the unlocking activation indicator of the chip card in a second state on receipt of the state-change command,

the mobile terminal reading the unlocking activation indicator in the chip card, and

if the read unlocking activation indicator is in the second state, ordering the mobile terminal to unlock the mobile terminal.

Activating the unlocking of the mobile terminal requires the presence of the chip card in the mobile terminal. The necessary interaction between the mobile terminal and the chip card increases the unlocking security. The operator thus controls the operation of the mobile terminals which it has subsidised up until the end of the predetermined period of use of the mobile terminal.

The method also makes it possible to verify the validity of the chip card and the locking status of the mobile terminal. The method then comprises the steps of:

reading a locking indicator in the mobile terminal,

if the locking indicator is in a first state, reading a card application indicator from the chip card and comparing it to an application indicator pre-stored in the mobile terminal in order to validate the card application,

if the card application is valid, reading personal card data stored on the chip card and comparing it to personal mobile data stored in the mobile terminal in order to validate the chip card, and

if the chip card is valid, performing the step of reading the unlocking activation indicator.

The invention also relates to a system for activating the unlocking of a mobile terminal which, before use, is intended to be associated with a telecommunications network and which cooperates with a chip card storing an unlocking activation indicator in a first state. The system is characterised in that it comprises:

means in the mobile terminal for periodically reading the unlocking activation indicator in the chip card so as to keep the mobile terminal locked if the read unlocking activation indicator is in the first state,

server means connected to the network for transmitting an update message, comprising a state-change command, to the chip card via the mobile terminal,

means in the chip card for placing the unlocking activation indicator in a second state on receipt of the state-change command, and

means in the mobile terminal for ordering the unlocking of the mobile terminal if the unlocking activation indicator read by the reading means is in the second state.

Further characteristics and advantages of the invention will appear more clearly from reading the following description of several preferred embodiments of the invention, provided as non-limiting examples, in reference to the appended drawings, wherein:

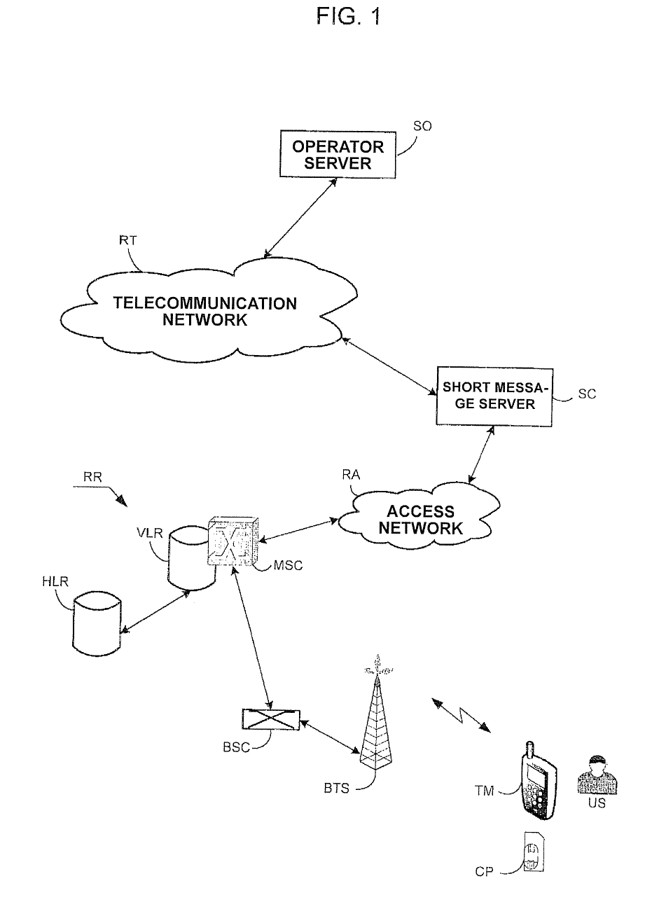

FIG. 1 is a schematic block diagram of a telecommunications link between an operator server and a mobile terminal for implementing the unlocking activation method according to the invention;

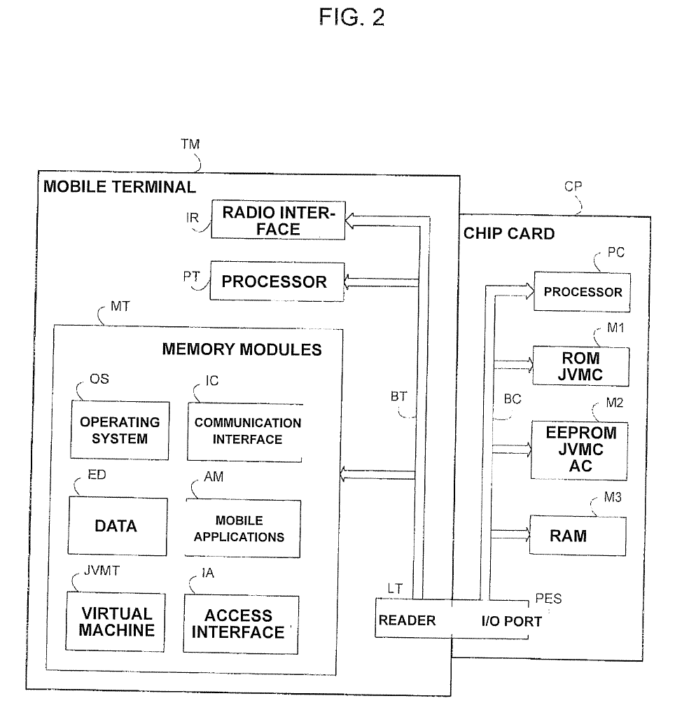

FIG. 2 is a schematic block diagram of a mobile radio terminal and a chip card including the invention; and

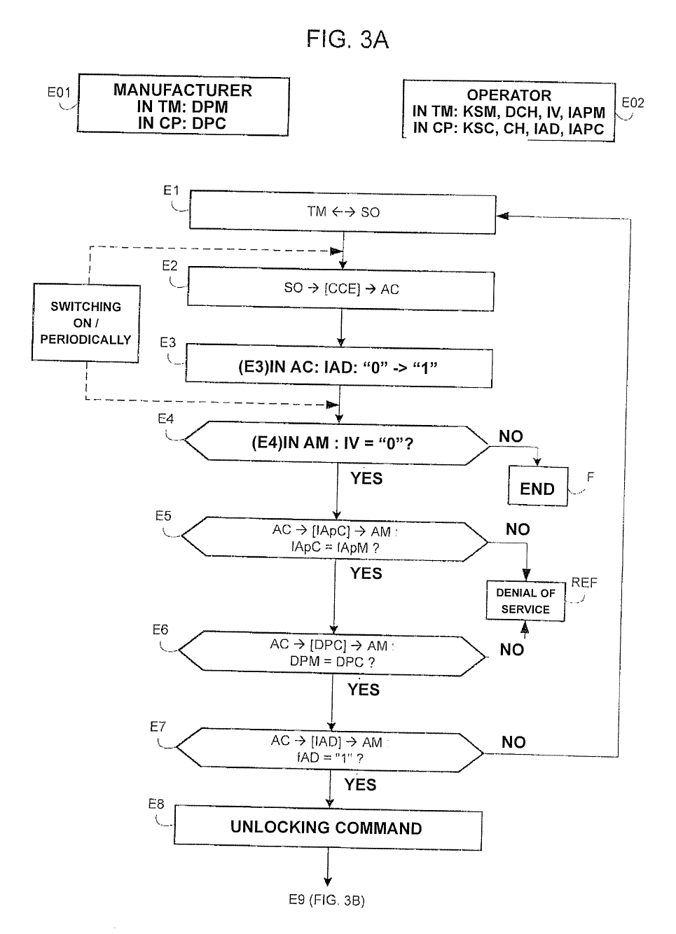

FIGS. 3A and 3B show an algorithm of the main steps of the unlocking method according to a preferred embodiment of the invention.

In relation to FIG. 1, a mobile radio terminal TM equipped with a removable user chip card CP is supplied to a user US by an operator which manages a digital cellular radio-communication network RR. The radio-communication network RR is, for example, of GSM type.

FIG. 1 only shows the main elements of the location area of the network RR where the mobile terminal TM is located at a given moment.

The location area comprises a mobile switching centre MSC which is connected through a base station controller BSC to a base station BTS connected by a radio link to the mobile terminal TM.

As is known, the network RR also comprises a home location register HLR connected to several visitor location registers VLR, including the one connected to the switching centre MSC of the location area in question. The HLR register is similar to a database containing, for each user, in particular, an IMSI (International Mobile Subscriber Identity) associated with the user and thus with the chip card CP, the user subscription profile and the number of the VLR register with which the mobile terminal TM is currently associated. The VLR register acts as a relay for the HLR register in the location area and contains characteristics of the users whose mobile terminals are located in the location area.

An operator server SO, acting as an OTA (Over-The-Air) service platform, is managed by the operator of the network RR.

According to the embodiment shown in FIG. 1, the operator server SO exchanges data messages with the mobile terminal TM through a short message service centre SC. The server SC comprises one access gateway for communicating with the operator server SO over a high data rate telecommunications network RT, in particular the internet or, as a variation, an intranet network, and another access gateway for communicating with at least the previously mentioned mobile switching centre MSC over an access network RA such as an X.25 packet-switched network or an ISDN or ATM network. The packets transmitted by the server SO are formatted in the server SC as short messages transmitted to the mobile terminal TM; conversely, the short messages transmitted by the mobile terminal TM are routed by the server SC in the form of packets addressed to the operator server SO.

According to a first variation, the short message server SC and the access network RA are replaced with a packet-switched access network with mobility management and GPRS (General Packet Radio Service) radio access. The telecommunications network RT is then connected to a GGSN (Gateway GPRS Support Node) node in the GPRS network, and the base station controller BSC is connected through an SGSN (Serving GPRS Support Node) node. This variation is useful in that it can transmit messages in the form of packets with much greater data rates.

According to a second variation, the cellular radio-communication network RR is a third-generation network, which is to say a UMTS network. In this case, the controller BSC and the base station BTS are grouped together in the UTRAN (UMTS Terrestrial Radio Access Network) access network of the UMTS network.

As a variation, the mobile terminal TM is a small device such as a personal digital assistant (PDA) which can communicate with networks and exchange commands and responses with a chip card.

FIG. 2 shows functional blocks in the mobile terminal TM and the chip card CP, the majority of which perform functions linked to the invention and which can correspond to software and/or hardware modules.

As a peripheral, the terminal TM contains a reader LT connected to an input/output port PES of the chip card CP with or without electrical contact.

Other than the chip card reader LT, the mobile terminal TM conventionally comprises a radio interface IR, a processor PT and memory modules MT. The various elements of the terminal are connected to each other by a bidirectional bus BT. The memory modules MT group together various memory modules, such as a read-only memory module ROM, a non-volatile memory module EEPROM and a RAM memory module. The radio interface IR transposes into frequencies, digitally converts, demodulates and decodes messages received over the network RR, and conversely transmits messages.

The memory modules MT in the terminal TM contain, in particular, an operating system OS, for example such as SYMBIAN, WINDOWS MOBILE, BREW or LINUX, an execution environment such as, for example, a Java virtual machine JVMT programmed in a Java language, for example J2ME, and data space ED for storing data such as parameters and indicators. The rest of the description will refer to a Java virtual machine.

In particular, mobile applications AM, initially written in a high-level object-oriented language such as the Java language compatible with the JVMT virtual machine, are implemented in the non-volatile memory of the memory modules MT. The mobile applications AM are also known as MIDlets (Mobile Information Device applet). The virtual machine JVMT communicates with a Java virtual machine JVMC installed in the chip card CP by means of a predetermined communication protocol, which is conventionally a half-duplex asynchronous protocol having protocol data units (APDU) made up of commands transmitted from the mobile terminal TM to the chip card CP and responses transmitted from the chip card CP to the mobile terminal TM. According to this protocol, for example the SIM Application Toolkit according to the 3GPP TS 51.0144 or ETSI 102.223 standard, the commands are always initiated by the mobile terminal.

In order for the mobile applications AM to communicate respectively with the card applications AC implemented in the chip card CP according to the predetermined communication protocol, an access interface IA for accessing the resources and data in the chip card is implemented in the memory MT, for example, in the form of a Java API (Application Programming Interface) program according to the JSR 177 specification in the case of a J2ME terminal which supports Java technology.

The memory modules MT also comprise a communication interface IC, for example the SIM Toolkit functionality set, so that a main SIM (Subscriber Identity Module) application or any other application in the chip card CP can communicate with the “outside world” via the mobile terminal, for example with the operator server SO. The communication interface IC manages commands and responses exchanged between the “outside world” and the main SIM application, for example in order to adapt them to short messages exchanged with the short message server SC of the network RR.

The chip card CP, also called smart card or integrated circuit card, constitutes a UICC (Universal Integrated Circuit Card) user identity module which can be removed from the mobile terminal TM. The chip card can be, for example, a SIM card for a GSM or GPRS cellular radio-communication network, or a USIM (Universal Subscriber Identity Module) or RUIM (Removable User Identity Module) module for a third-generation (3GPP) CDMA (Coded Division Multiple Access) network such as UMTS (Universal Mobile Telecommunications System), or a third-generation (3GPP2) network such as CDMA 2000.

The chip card CP conventionally comprises a processor PC, a non-rewritable ROM or Flash memory M1, a non-volatile EEPROM or a Flash memory M2 and a RAM or SRAM memory M3 intended essentially for exchanging commands, or requests, and responses with the mobile terminal TM via the input/output port PES and the reader LT. The various elements of the card CP are connected to each other by a bidirectional bus BC.

The memory modules M1 and M2 contain the codes and data of, for example, an operating system and the virtual machine JVMC according to the Java Card specification, or any other operating system. The non-volatile memory M2 contains applications such as the SIM or USIM application, initially installed when manufacturing the card, and a memory space mainly for storing keys, identity numbers and other characteristics of the subscriber profile of the user owning the chip card. The memory module M2 also comprises a memory space for storing card applications AC, which constitute STK applets, for example SIM ToolKit.

According to a preferred embodiment of the invention shown in FIGS. 3A and 3B, prior to selling and using the mobile terminal TM with the chip card CP, the unlocking activation method according to the invention comprises two initial personalisation steps E01 and E02 which are performed by the mobile terminal manufacturer and the network operator RR which has ordered a batch of mobile terminals, each equipped with a chip card, from the manufacturer.

In step E01, the manufacturer inputs personal mobile data DPM which are specific to the mobile terminal TM and personal card data DPC which are specific to the chip card CP. The DPM and DPC data comprise at least one country code MCC and one operator code MNC specific to the network operator RR. As a variation, the DPM and DPC data comprise the international chip card identifier IMSI including the MCC and MNC codes. The DPC and DPM data therefore have common elements so as to establish a unique correspondence between the mobile terminal and the chip card.

As a variation, the personal card data DPC are not input by the manufacturer, but by the operator in the next step E02.

The manufacturer then delivers the batch of mobile terminals, which have had the aforementioned data loaded onto them during step E01, to the radio-communication network operator RR.

In step E02, the operator records a secret mobile key KSM in each mobile terminal of the delivered batch, obtained, for example, by applying a terminal identifier IMEI and the MNC code to a security algorithm. The operator also installs in the mobile terminal a decryption algorithm DCH, having the secret key KSM as a key, a locking indicator IV set to a first logical state, “0”=locked state, an application indicator IApM and at least one unlocking application. The operator also installs in the chip card CP contained in the mobile terminal TM a secret card key KSC, an encryption algorithm CH having the secret key KSC as a key, an unlocking activation indicator IAD set to a first logical state, “0”=unlocking forbidden, and an application indicator IApC. The decryption algorithm DCH is, for example, of AES (Advanced Encryption Standard) type and is used to decrypt the data encrypted by the encryption algorithm CH or transmitted by the server SO. The unlocking application can depend on personal mobile data DPM stored in the terminal during step E01 and which can be modified by the operator. The unlocking application obliges the future user US of the mobile terminal TM only to communicate over the radio-communication network RR of the operator that sold him/her the terminal for a predetermined locked period, typically six months.

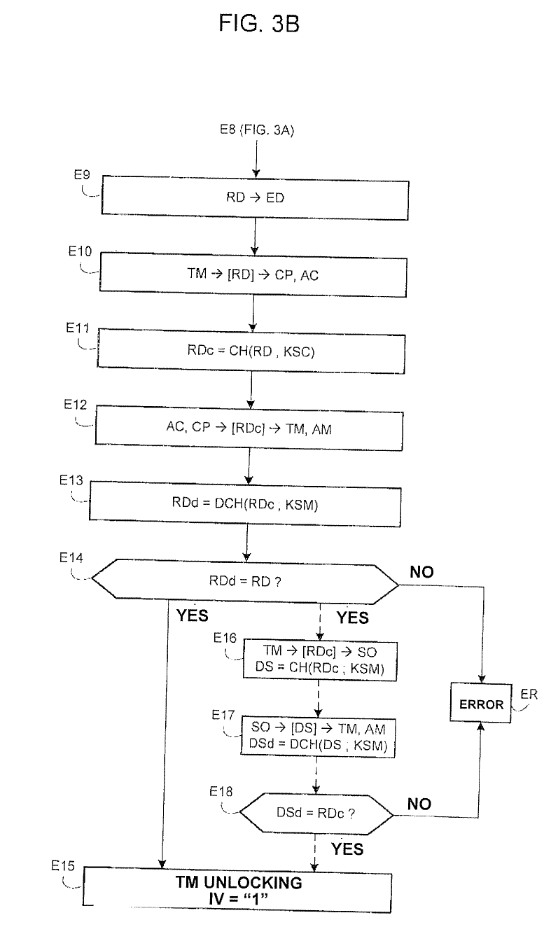

A user US uses a mobile terminal TM for the predetermined locked period, communicating over the radio-communication network RR of the operator which sold him/her the mobile terminal with a chip card CP, or one of the partner operators of said operator. The user US may want to unlock his/her mobile terminal TM in order potentially to use it with the radio-communication network of another operator at the end of the predetermined locked period. In order to activate the unlocking of the mobile terminal, steps E1 to E15 shown in FIGS. 3 and 4 are performed according to the preferred embodiment of the unlocking activation method according to the invention.

In step E1, the user US places an unlocking request with the operator. For example, the user selects a command to unlock the mobile terminal TM from a menu displayed on the mobile terminal or enters an unlocking command code, taken from an operator document.

In this case, the mobile terminal TM transmits an unlocking request message to the operator server SO, in the form of a short message according to the embodiment shown in FIG. 1, which is then transformed by the short message server SC into a packet transmitted over the network RT.

In step E2, the server SO then sends an update message over the networks RP, RA and RR to the chip card CP via the communication interface IC of the mobile terminal TM. The update message comprises a state-change command CCE which is temporarily stored in the chip card memory M3 so as to be executed by the card application AC.

According to a variation, the mobile terminal TM does not transmit an unlocking request message to the operator server SO and the mobile terminal user calls an operator customer service centre for the operator server to transmit the update message to the mobile terminal; or else, the user calls a service company which manages the unlocking of mobile terminals in order for a service server connected to the network RR to send the update message to the mobile terminal.

According to another variation, the update message is automatically transmitted to the chip card at the end of the predetermined locking time. For example, the update message is sent by the server SO in response to a location update request from the mobile terminal, or after an authentication request, or even after switching on the mobile terminal during the process of associating it with its location area in the radio-communication network RR.

In step E3, after receiving the secured and potentially encrypted update message in the chip card CP, in order to ensure the integrity and confidentiality of the update message, the card application AC interprets the state-change command CCE in order to place the unlocking activation indicator IAD in a second logical state, “1”=unlocking authorisation, in an event space of the memory M2.

According to a variation, the update message only comprises the unlocking activation indicator IAD in a second state “1” which is stored directly in the memory M2 of the chip card.

According to another variation, the state-change command CCE is initially installed on the chip card at the initiative of the operator and automatically executed after the predetermined locking period on receipt of a locking period expiration signal transmitted by the “outside world”. It is therefore no longer necessary to resort to the server SO for transmitting the update message.

The method then passes on to steps E4, E5, E6 and E7 shown in FIG. 3A. These steps relate to verifying the validity of the chip card CP and the unlocking status of the mobile terminal TM, and are triggered every time a predetermined cyclic period ends and/or every time the mobile terminal TM is switched on during the predetermined locking period. In the latter case, the user US is then asked to switch the mobile terminal TM off again so that the verification steps E4 to E7 can be performed.

In step E4, the mobile application AM reads the locking indicator IV in the data space ED of the memory modules MT of the mobile terminal TM. When the locking indicator IV is in the first state, “0”=locked state, the mobile application AM requires the launching of a verification session between the mobile application AM and the card application AC in the access interface IA. If the locking indicator IV is not in the first state “0”, the process ends, as indicated in step F, meaning that the mobile terminal is already unlocked.

In step E5, when the verification session is launched, the mobile application AM transmits a first action command to the card application AC in order to verify the validity of the card application AC in the chip card CP. For example, the card application AC transmits the application indicator IApC previously stored in the card CP to the mobile application AM which compares it to the application indicator IApM previously stored in the terminal TM. According to another example, the mobile application AM transmits the application indicator IApM previously stored in the terminal TM to the card application AC which compares it to the indicator IApC previously stored in the card. If the compared application indicators are identical, the card application AC is considered to be valid.

In step E6, if the card application AC is valid, the mobile application AM transmits a second action command to the card application AC in order to verify the validity of at least one of the personal card data DPC stored in the chip card CP. In the same way as step E5, the card application AC transmits a response comprising the personal card datum DPC to the mobile application AM which compares it to the personal mobile datum DPM stored in the mobile terminal. As a variation, the mobile application AM transmits a response with the mobile datum DPM to the card application AC which compares it to the datum DPC stored in the card CP. For example, the personal datum DPC to be compared comprises the country code MCC and the operator code MNC or the international card identifier IMSI. In the same way, if the compared personal card data and personal mobile data are identical, the personal card data DPC is considered to be valid.

After step E6, the application AM in the mobile terminal authorises command and response exchanges according to a conventional operation mode with the card application AC as the chip card is the one initially acquired with the mobile terminal. The chip card is thus validated by the mobile terminal.

At the end of step E5, if the card application is not valid, or at the end of step E6, if the personal card datum DPC is not valid, for example after inserting a chip card sold by another operator in the mobile terminal, a denial-of-service command is launched by the mobile application AM, as indicated in a step REF. This command is executed in order to prevent a normal usage of the terminal by requiring the mobile application to make a request to the chip card and by attempting to saturate the exchanges between the card and the terminal, and/or, in order to render the mobile terminal TM unusable, for example by automatically forbidding at least all outgoing calls, with a view to countering an unauthorised unlocking operation from a malicious user.

In step E7, if the chip card is valid, the mobile application AM transmits a third action command to the card application AC in order to read the unlocking activation indicator IAD stored in the memory M2 of the chip card CP. The card application AC sends the read unlocking activation indicator IAD back to the mobile application AM.

In step E8, if the unlocking indicator IAD is in the second state, “1”=unlocking authorisation, the mobile application AM orders the unlocking of the mobile terminal TM by launching the unlocking application installed by the operator in step E02. The unlocking application requires the launching of an unlocking session between the mobile AM and card AC applications in the access interface IA. If the unlocking indicator IAD is still in the first state, “0”=unlocking forbidden, in step E7, the mobile terminal remains locked and the user is asked to call the customer service centre of the operator in order to receive a new update message.

Unlocking steps E9 to E15, shown in FIG. 3B, also use, in a conventional manner, the principle of authentication between a mobile terminal and authentication means. As an example, steps E9 to E15 relate to the authentication of the chip card by the mobile terminal. However, the authentication can be an authentication of the mobile terminal by the chip card, or even a mutual authentication between the mobile terminal and the chip card.

In step E9, a random number RD is generated by a pseudo-random number generator included in or connected to the microcontroller of the terminal TM and stored in the data space ED of the mobile terminal TM.

In step E10, the random number RD is then transmitted from the mobile terminal TM to the chip card CP. The transmitted random number RD is temporarily stored in the memory M3 of the chip card in order to be processed by the card application AC.

In step E11, the card application AC applies the transmitted random number RD to the encryption algorithm CH, which has the secret card key KSC as its key, so as to produce an encrypted random number RDc.

In step E12, the encrypted random number RDc is transmitted to the mobile terminal TM, where it is stored. Then, in step E13, the mobile application AM applies the encrypted random number RDc to the decryption algorithm DCH, which has the secret mobile key KSM as its key, in order to decrypt the number RDc into the decrypted number RDd. In the mobile application AM, the decrypted number RDd is compared, during step E14, to the random number RD previously stored during step E9. When the compared numbers RD and RDd are identical, the card application AM activates the unlocking application in step E15. The user is then informed that the mobile terminal TM is unlocked, for example by a message on the terminal screen.

Conversely, if the numbers compared in step E14 are different, the mobile terminal TM produces an error message, as indicated in a step ER. The error message is transmitted to the operator server SO which interprets it as a malfunction of the terminal TM and/or the card CP and the terminal TM is not unlocked.

In the case that RDd=RD, the locking indicator IV is then set to a second logical state, “1”=unlocked state, and the verification steps E5 to E7, which were performed at least every time the mobile terminal TM was switched on and/or periodically, are no longer required. Indeed, the next time the mobile terminal is switched on, when the mobile application AM reads the locking indicator IV, which is in the second state, it will no longer be necessary to verify the validity of the chip card comprised within the mobile terminal, the latter being unlocked.

As a variation, steps E16, E17 and E18 shown in dotted lines in FIG. 3B are performed after step E14 when the compared numbers RDd and RD are identical.

In step E16, the mobile terminal retransmits the encrypted random number RDc to the server SO via the short message server SC. The server SO encrypts the random number RDc by applying it to the encryption algorithm CH with the secret key of the card KSC and produces a security datum DS, in a similar manner to step E11, performed by the chip card. The server SO transmits the security datum DS to the mobile terminal TM via the short message server SC in step E17. As specified in step E02, the decryption algorithm DCH is also used to decrypt data encrypted and transmitted by the server SO; in this case, the security datum DS is applied to the decryption algorithm DCH which decrypts it into a decrypted security datum DSd.

Then in step E18, the mobile application AM compares the decrypted security datum DSd to the random number RDc stored previously during step E12. When the decrypted security datum DSd is identical to the transmitted random number RDc, the card application AM activates the unlocking application in step E15.

Conversely, if the decrypted security datum DSd and the random number RDc compared in step E18 are different, the mobile terminal TM produces, for example, an error message in step ER.

The intervention of the server in the exchanges of encrypted data thus increases the security of the unlocking method.

1. Method of activating the unlocking of a mobile terminal (TM) which, before use, is intended to be associated with a radio-communication network (RR) and which cooperates with a chip card (CP) storing an unlocking activation indicator (IAD) in a first state, characterised in that it comprises:
a periodic step of the mobile terminal reading (E7) the unlocking activation indicator (IAD) in the chip card so as to keep the mobile terminal locked if the read unlocking activation indicator (IAD) is in the first state, and
the following steps of:
transmitting (E2) an update message comprising a state-change command (CCE) from server means (SO) connected to the network (RR) to the chip card (CP) via the mobile terminal,
placing (E3) the unlocking activation indicator in the chip card (CP) in a second state, on receipt of the state-change command (CCE),
the mobile terminal reading (E7) the unlocking activation indicator (IAD) in the chip card, and
if the read unlocking activation indicator (IAD) is in the second state, ordering (E8) the mobile terminal to unlock the mobile terminal.

2. Method according to claim 1, further comprising steps of:
reading (E4) a locking indicator (IV) in the mobile terminal (TM),
if the locking indicator (IV) is in a first state, reading (E5) a card application (AC) indicator (IApC) from the chip card (CP) and comparing it to an application indicator (IApM) pre-stored in the mobile terminal in order to validate the card application,
if the card application (AC) is valid, reading (E6) personal card data (DPC) stored on the chip card and comparing it to personal mobile data (DPM) stored in the mobile terminal (TM) in order to validate the chip card, and
if the chip card is valid, performing the step of reading (E7) the unlocking activation indicator (IAD).

3. Method according to claim 2, according to which the reading steps (E4-E7) are triggered every time the mobile terminal is switched on.

4. Method according to claim 2, according to which the personal card data (DPC) includes at least part of an international identifier (IMSI) of the chip card.

5. Method according to claim 1, further comprising the following steps of:
storing (E01) a secret mobile key (KSM) in the mobile terminal and a secret card key (KSC) in the chip card,
generating (E9) and storing a random number (RD) in the mobile terminal (TM),
transmitting (E10) the random number (RD) from the mobile terminal (TM) to the chip card (CP),
in the chip card (CP), applying (E11) the transmitted random number (RD) to an encryption algorithm (CH), which has the secret card key (KSC) as its key, so as to generate an encrypted random number (RDc),
transmitting and storing (E12) the encrypted random number (RDc) in the mobile terminal (TM), and
decrypting (E13) the encrypted random number (RDc) into a decrypted number (RDd) in the mobile terminal by means of a decryption algorithm (DCH), which has the secret mobile key (KSM) as its key, so as to compare it (E14) to the stored random number (RD), and
unlocking (E15) the mobile terminal when the compared numbers are identical.

6. Method according to claim 5, further comprising the following steps of:
transmitting (E16) the encrypted random number (RDc) from the mobile terminal (TM) to the server means (SO) and encrypting the encrypted random number in a security datum (DS) by means of the encryption algorithm (CH) in the server means,
transmitting (E17) the security datum from the server means to the mobile terminal and decrypting (E13) the security datum in the mobile terminal into a decrypted security datum (DSd) by means of the decryption algorithm (DCH), and
comparing (E18) the decrypted security datum (DSd) to the encrypted random number (RDc) so as to unlock (E15) the mobile terminal when the decrypted security datum is identical to the encrypted random number.

7. System for activating the unlocking of a mobile terminal (TM) which, before use, is intended to be associated with a radio-communication network (RR) and which cooperates with a chip card (CP) storing an unlocking activation indicator (IAD) in a first state, characterised in that it comprises:
means in the mobile terminal (AM) for periodically reading the unlocking activation indicator (IAD) in the chip card so as to keep the mobile terminal locked if the read unlocking activation indicator (IAD) is in the first state,
server means (SO) connected to the network (RR) for transmitting (E2) an update message comprising a state-change command (CCE) to the chip card (CP) via the mobile terminal,
means (AC) in the chip card for placing the unlocking activation indicator in a second state on receipt of the state-change command (CCE), and
means (AM) in the mobile terminal for ordering the unlocking of the mobile terminal, if the unlocking activation indicator (IAD) read by the reading means (AM) is in the second state.

8. Method according to claim 3, according to which the personal card data (DPC) includes at least part of an international identifier (IMSI) of the chip card.

9. Method according to claim 2, further comprising the following steps of:
storing (E01) a secret mobile key (KSM) in the mobile terminal and a secret card key (KSC) in the chip card,
generating (E9) and storing a random number (RD) in the mobile terminal (TM),
transmitting (E10) the random number (RD) from the mobile terminal (TM) to the chip card (CP),
in the chip card (CP), applying (E11) the transmitted random number (RD) to an encryption algorithm (CH), which has the secret card key (KSC) as its key, so as to generate an encrypted random number (RDc),
transmitting and storing (E12) the encrypted random number (RDc) in the mobile terminal (TM), and
decrypting (E13) the encrypted random number (RDc) into a decrypted number (RDd) in the mobile terminal by means of a decryption algorithm (DCH), which has the secret mobile key (KSM) as its key, so as to compare it (E14) to the stored random number (RD), and
unlocking (E15) the mobile terminal when the compared numbers are identical.

10. Method according to claim 3, further comprising the following steps of:
storing (E01) a secret mobile key (KSM) in the mobile terminal and a secret card key (KSC) in the chip card,
generating (E9) and storing a random number (RD) in the mobile terminal (TM),
transmitting (E10) the random number (RD) from the mobile terminal (TM) to the chip card (CP),
in the chip card (CP), applying (E11) the transmitted random number (RD) to an encryption algorithm (CH), which has the secret card key (KSC) as its key, so as to generate an encrypted random number (RDc),
transmitting and storing (E12) the encrypted random number (RDc) in the mobile terminal (TM), and
decrypting (E13) the encrypted random number (RDc) into a decrypted number (RDd) in the mobile terminal by means of a decryption algorithm (DCH), which has the secret mobile key (KSM) as its key, so as to compare it (E14) to the stored random number (RD), and
unlocking (E15) the mobile terminal when the compared numbers are identical.

11. Method according to claim 4, further comprising the following steps of:
storing (E01) a secret mobile key (KSM) in the mobile terminal and a secret card key (KSC) in the chip card,
generating (E9) and storing a random number (RD) in the mobile terminal (TM),
transmitting (E10) the random number (RD) from the mobile terminal (TM) to the chip card (CP),
in the chip card (CP), applying (E11) the transmitted random number (RD) to an encryption algorithm (CH), which has the secret card key (KSC) as its key, so as to generate an encrypted random number (RDc),
transmitting and storing (E12) the encrypted random number (RDc) in the mobile terminal (TM), and
decrypting (E13) the encrypted random number (RDc) into a decrypted number (RDd) in the mobile terminal by means of a decryption algorithm (DCH), which has the secret mobile key (KSM) as its key, so as to compare it (E14) to the stored random number (RD), and
unlocking (E15) the mobile terminal when the compared numbers are identical.

12. Method according to claim 8, further comprising the following steps of:
storing (E01) a secret mobile key (KSM) in the mobile terminal and a secret card key (KSC) in the chip card,
generating (E9) and storing a random number (RD) in the mobile terminal (TM),
transmitting (E10) the random number (RD) from the mobile terminal (TM) to the chip card (CP),
in the chip card (CP), applying (E11) the transmitted random number (RD) to an encryption algorithm (CH), which has the secret card key (KSC) as its key, so as to generate an encrypted random number (RDc),
transmitting and storing (E12) the encrypted random number (RDc) in the mobile terminal (TM), and
decrypting (E13) the encrypted random number (RDc) into a decrypted number (RDd) in the mobile terminal by means of a decryption algorithm (DCH), which has the secret mobile key (KSM) as its key, so as to compare it (E14) to the stored random number (RD), and
unlocking (E15) the mobile terminal when the compared numbers are identical.
